(19) United States
(12) Patent Application Publication
(10) Pub. No.: US 2005/0071298 A1
(43) Pub. Date: Mar. 31, 2005

(54) Distributed computing connected via the World Wide Web with a system for tracking the distribution of computer power from client providers to consumers so as to compensate client providers and bill user consumers

(75) Inventors: Ira R. Forman, Austin, TX (US); Lane Thomas Holloway, Pflugerville, TX (US); Nadeem Malik, Austin, TX (US); Marques Benjamin Quiller, Pflugerville, TX (US)

Correspondence Address: Mark E. McBurney;International Business Machines Corporation, Intellectual Property Law Department, 11400 Burnet Road, Internal Zip 4054, Austin, TX, 78758, US

(73) Assignee: International Business Machines Corporation, Armonk, NY (US)

(21) Appl. No.: 10/675,675

(22) Filed: Sep. 30, 2003

(51) Int. Cl. G06F 17/60

(52) U.S. Cl. 705/412; 705/26

(57) ABSTRACT

A method of doing business that enables a computer power service broker operating over the World Wide Web (Web) to distribute and track such distribution of computer power. The computer power service broker solicits: each of a plurality of client computer stations on the Web to offer for general distribution over the Web computer power in excess to the computer power requirements of each respective client computer station; and a plurality of consumer stations on the Web to request the performance of functions requiring computer power. The broker then distributes each of said requested functions requiring computer power among a plurality of said client stations offering said computer power and then tracks and bills consumer stations for computer power used in performance of requested functions. Finally, the computer power broker tracks and compensates the client stations for the excess computer power that they contribute in performance of the requested functions. The compensation may be determined by the market value of the broken down functions or tasks.

### TECHNICAL FIELD

The present invention relates to computer managed communication networks such as the World Wide Web (Web) and, particularly, to systems, processes and programs for the distribution of computer power, i.e. distributed data processing carried out over the Web.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web (the two terms are used interchangeably) related distribution of documents, media and programs. The convergence of the electronic entertainment and consumer industries with data processing exponentially accelerated the demand for wide ranging communications distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

Because of the pervasiveness of the Internet or Web, it is expected that it would be considered as an available network for distributed data processing or distributed computing. Distributed computing has conventionally been used for projects that require large amounts of computing power. One typical example is finding a 100,000 digit prime number. It has been estimated that testing just one 100,000 prime number would take a 500 mhz computer one year. Thus, such tasks have been cumbersome for even super computers. This need initially gave rise to distributed computing to cover projects related to the environment, genetics, disease control and like scientific research related to the preservation and advancement of civilization. Now, with the availability of the Web linking computers throughout the world, important research projects requiring the application of tremendous computing power have been using volunteers to permit research project management to distribute computing functions over the Web to the volunteer computers that perform such functions as secondary or background functions that do not interfere with the primary functioning of the volunteer computers. In such distributed computing, the reward to the volunteer computer host is the spiritual compensation that they are doing something in the progress of civilization.

On the other hand, distributed data processing has been available for years within business organizations to break down functions requiring large amounts of computer power over relatively short periods of time, and networks and even the Web have been used in the distribution of such data processing internal to business organizations.

However, in light of the extensive distributive network offered by the Web to all matter of computers and computing power, together with continuous advancement of distributive computing technology, greater opportunities are offered for distributive computing over the Web. The present invention develops such an approach to distributive computing over the Web.

### SUMMARY OF THE PRESENT INVENTION

The present invention provides a method, system and program of doing business that enables a computer power service broker operating over the Web to distribute and track such distribution of computer power. The computer power service broker solicits: each of a plurality of client computer stations on the Web to offer for general distribution over the Web computer power in excess to the computer power requirements of each respective client computer station; and a plurality of consumer stations on the Web to request the performance of functions requiring computer power. The broker then distributes each of said requested functions requiring computer power among a plurality of said client stations offering said computer power; and then tracks and bills consumer stations for computer power used in performance of requested functions. Finally, the computer power broker tracks and compensates the client stations for the excess computer power that they contribute in performance of the requested functions. The compensation may be determined by the market value of the broken down functions or tasks.

It should be noted that with such a broker arrangement, the consumer stations need not be the previously described projects or organizations requiring tremendous amounts of computer power for large scale scientific research. The consumers may just be stations wishing to outsource, i.e. request the performance of, some computer functions. With the current emphasis on “lean and mean” business organizations, it may very well be the case that a business may wish to wait before it is ready to invest in more data processing resources upon an increase in computer power demands that may turn out to be temporary. Under such conditions, businesses may be very amenable to the outsourcing of computer functions enabled by this invention.

On the other hand, in the case where the client computer makes a voluntary contribution wherein the consumer stations requesting the performance of functions requiring computer power are owned by charitable organizations, then the step of compensating said client stations for said computer power compensates said client stations by providing a Web document indicating the contribution of the market value of the computer power supplied.

In the fundamental application of the present invention, the market value of the computer power provided by each client station is determined by the amount of data processed and the type of data processing used in processing the data.

When a client computer station solicited by the computer power service broker agrees to participate in the distributed Web computing system, the client station permits the computer power service broker to access, via the Web, the computer power of said client station, and there is then distributed through the broker via the Web to said client station, a process, e.g. program or routine, permitting said computer power service broker to access the computer power of said client station.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the receiving display station on which the received Web pages may be displayed. The system may be used for conventional servers used throughout the Web for Web access servers, source database servers, as well as the servers used by the service providers in accordance with this invention;

FIG. 2 is a generalized diagrammatic view of a Web portion upon which the present invention may be implemented;

FIG. 3 is a general flowchart of a program set up to implement the present invention for a computer power service broker tracking distributed computer power to users and compensating client computer power providers; and

FIG. 4 is a flowchart of an illustrative run of the program set up in FIG. 3.

### DETAILED DESCRIPTION OF THE PREFERRED EMBODIMENT

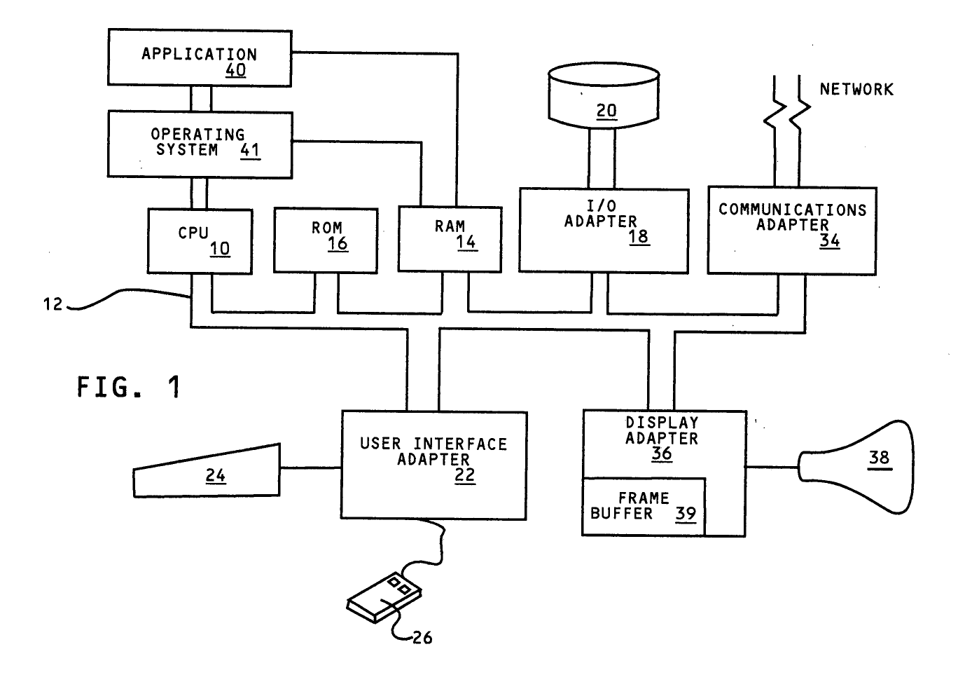

Referring to FIG. 1, a typical data processing terminal is shown that may function as the receiving, both computer power consumer and computer power provider, clients display station on which the received Web documents may be displayed. The system may also be used for conventional servers used throughout the Web for Web servers, as well as the servers used by the computer power service brokers in accordance with this invention.

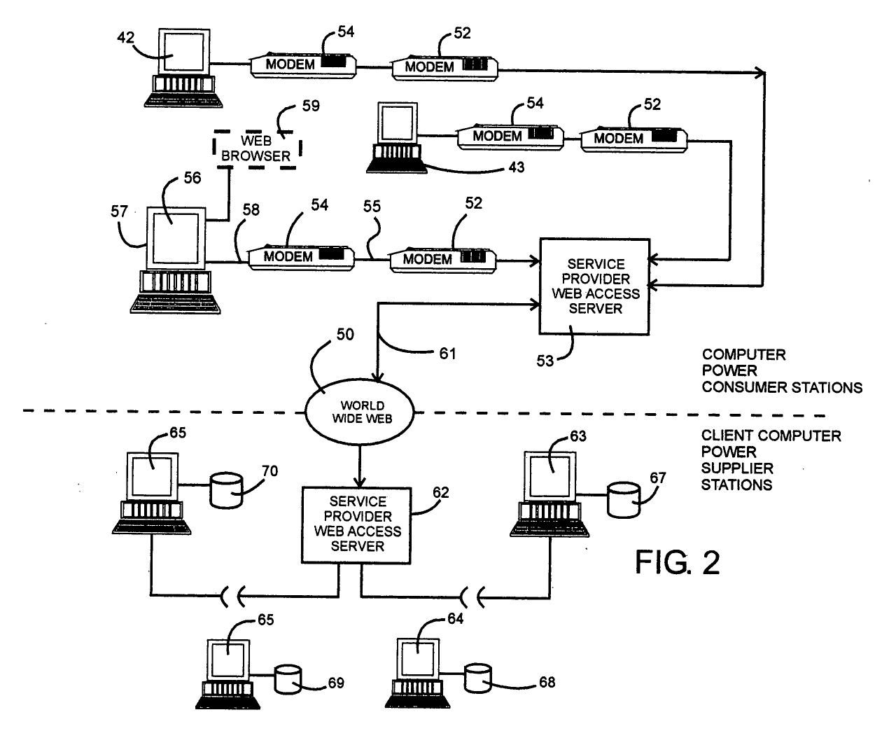

Before there is any further description of the respective computer functions in the present invention, a generalized example of distributed computing via the Web will be considered with respect to FIG. 2, which shows a generalized portion of the Web to illustrate the invention. It will be helpful to understand from a more general perspective the various elements and methods that may be related to the present invention. Since a major aspect of the present invention is directed to documents, such as Web pages and media content therein, transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images, as well as computer programs. This displayable information may be still, in motion or animated, e.g. animated GIF images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the text, Mastering the Internet, particularly at pp. 637-642, on HTML in the formation of Web pages. In addition, aspects of this description will refer to Web browsers. A general and comprehensive description of browsers may be found in the above-mentioned Mastering the Internet text at pp. 291-313. More detailed browser descriptions may be found in the text, Internet: The Complete Reference, Millennium Edition, M. L. Young et al., Osborne/McGraw-Hill, Berkeley Calif., 1999, Chapter 19, pp. 419-454, on the Netscape Navigator; Chapter 20, pp. 455-494, on the Microsoft Internet Explorer; and Chapter 21, pp. 495-512, covering Lynx, Opera and other browsers.

As for distributed computing or data processing systems, in its broadest sense, it may involve an environment wherein idle CPU cycles and storage spaces of from tens to thousands of computers networked together, e.g. over the Web to work on problems that conventionally have been processing intensive. Such distributed computing over the Web and like networks was, in the past, hampered by bandwidth limitations. However, recent dramatic increases in available bandwidth, as well as the greatly increased CPU power on the ubiquitous desktop computers, has made potential applications for distributed computing via the Internet or Web much more practical.

The concepts of the present invention are applicable to grid computing that usually involves larger computer systems initially set up for distributed computing so that the computing power needed is distributed among powerful workstations, even mainframes and super computers, and the problems involve the processing of very large data sets. In the embodiment of the invention to be described, the distributed computing will involve the soliciting and pooling of the computer power of many networked end users or receiving stations, “client computers”, of more limited processing power and whose primary function is not distributed computing.

It is primarily to this latter group of client computers that the present invention is directed. In the present invention, a Web service provider, such as service provider 53 in FIG. 2, assumes a computer power service broker in order to track the distributed computer power from the group of client computer power supplier stations 63 through 66 on the Web supplied to computer power consumer stations 57, 42 and 43 also on the Web; and accordingly bill the consumer stations for the computer power used and compensate the client supplier stations for the supplied computer power. For purposes of the present embodiment, computer 57 serves as a typical receiving Web display station that will access Web documents, e.g. pages that are displayed 56. Reference may be made to the above-mentioned Mastering the Internet, pp. 136-147, for typical connections between local display stations to the Web via network servers; any of which may be used to implement the system on which this invention is used. The system embodiment of FIG. 2 has a host-dial connection. Such host-dial connections have been in use for over 30 years through network access servers 53 that are linked 61 to the Web 60. The Web server 53 functions as a computer power service broker, and may be maintained by a Web Service Provider to display terminal 57. Such Web or Internet Service Providers (ISPs) are described generally in the above-mentioned text, Internet: The Complete Reference, Millennium Edition at pages 14-18. The Web server 53 is accessed by the receiving terminal 57 through a normal dial-up telephone linkage 58 via modem 54, telephone line 55 and modem 52. Any conventional digital or analog linkages, including wireless connections, are also usable. Web browser program 59 functions as described above to access the service provider 53 that functions herein as the computer power service broker. Receiving terminal computers 42 and 43 that are similar to terminal 57 are connected to the computer power service broker 53 and are just illustrative of other computer power consuming terminals on the Web.

Now in an illustrative operation, computer power broker 53 solicits computer stations on the Web for jobs or projects that may require distributed computing or data processing. Assume that each of Web computer stations 57, 42 and 43 responds, e.g. interactively, to a Web page from broker 53 offering to have such projects completed through distributed processing. Broker 53 has also solicited client computer power supplier stations 63 through 66 together with their respective database resources 67 through 70 to agree to do the distributed data processing as required by broker 53. This provision of computer power and storage resources by computer stations 63 through 66 is agreed to be only resources and power in excess of those required by stations to perform their own respective functions. At this point, stations 63 through 66 have interactively, via the Web through their Web service provider 62, agreed to participate in the distributed data processing during background or computer idle time. As will be hereinafter described in greater detail with respect to the programming of the present invention, service provider broker 53 distributes and installs over the Web 60 via the server of service provider 62 a relatively simple program routine that detects when the computer station 63 through 66 is idle and notifies a management server, e.g. server 62. The client computer 63 through 66 then receives a data package via the Web that it runs when it has spare CPU cycles and sends the results back through server 62 via the Web to broker 53 that collects the distributed processing, puts the job or project function results together, bills the respective consumer station 57, 42 or 43 and compensates the client computer power providers station compensation, as will be hereinafter described.

Returning now to the description of the basic computer of FIG. 1, the illustrative computer shown may function as any of stations 42, 42, 57 and 63 through 67. The system may also be used for conventional servers used throughout the Web for Web access servers, source database servers, as well as the servers used by the service providers in accordance with this invention, e.g. for the computer power service broker. A central processing unit (CPU) 10, such as one of the PC microprocessors or workstations, e.g. RISC System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs include the program of the present invention that will be described hereinafter for operations wherein the system of FIG. 1 functions as the server used by the service providers in accordance with this invention. The programs will distribute job or project computer functions requested to be done by computer power consumer stations to the client computers providing the computer power and, accordingly, bill and compensate the respective computer hosts and owners. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs of this invention. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through keyboard 24 or mouse 26 and receiving output information from the system via display 38.

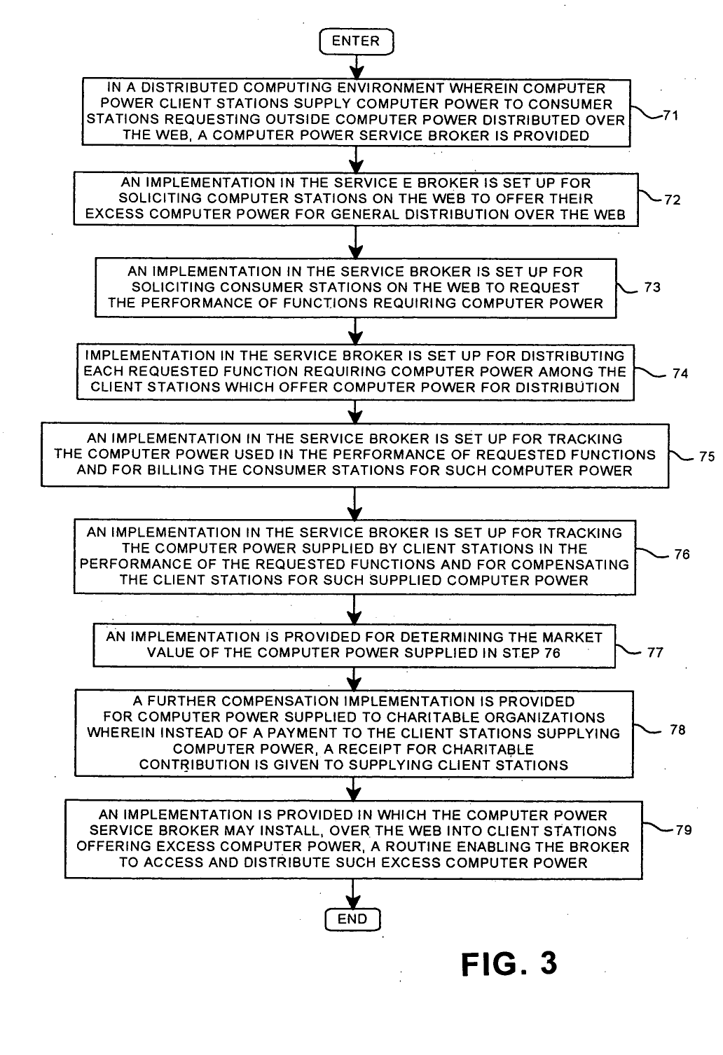

FIG. 3 is a flowchart showing the development of a process according to the present invention for distributing job or project computer functions requested to be done by computer power consumer stations to the client computers providing the computer power, and accordingly billing and compensating the respective computer hosts and owners. Many of the programming functions in the process of FIG. 3 have already been described in general with respect to FIGS. 1 and 2. In the Web, service providers are available between the Web document requesting and receiving display stations and other of such requesting and receiving stations and the database sources on the Web. These Web service providers conventionally provide servers to aid users in accessing documents from the Web and/or providing servers to distribute documents to and from the Web receiving computer stations and other database sources, e.g. Web sites. In such a Web environment, there is set up distributed computing in which client Web stations supply computer power to perform functions for Web computer stations, i.e. consumer stations requesting outside distributed computer power to perform such functions under the control of a computer power service broker, step 71. In the preferred implementation, as described above, a Web service provider would take this broker function. The service provider/broker would solicit computer stations on the Web to offer their excess computer power for carrying out distributed functions over the Web, step 72. The service broker would also be set up to solicit other computer stations on the Web having functions needing additional computer power beyond their capacity to carry out high computation projects to request the distributed performance of such functions, step 73. An implementation is set up in the service provider broker for distributing each requested function requiring computer power among the client stations offering such power for distribution, step 74. The service broker is set up to total the computer power provided and to bill the consumer stations for the total computer power provided. The charge for the computer power could be based upon market value of such power, e.g. the total number of bytes processed; or the total of computer time used. Both of these calculations could be varied dependent on the type of function being performed, step 75. The service broker is also set up to track the computer power provided by each client station in the distributed function and for compensating the respective client stations for such functions, step 76. A further implementation, step 77, is set up for determining the market value of the computer power supplied as determined in step 76 by using the criteria set forth above with respect to step 75. A special compensation arrangement is set up for a prevalent arrangement wherein the computer power is supplied to a charitable organization. In such a set up, the client computer is provided with a receipt for the charitable contribution of the value of the provided computer power instead of a payment, step 78. In the Web set up, an implementation is provided in which the service broker installs over the Web into each client station wishing to participate in the distribution, a program routine that will enable the broker to access and distribute the computer power and to track and compensate for such supplied computer power, step 79.

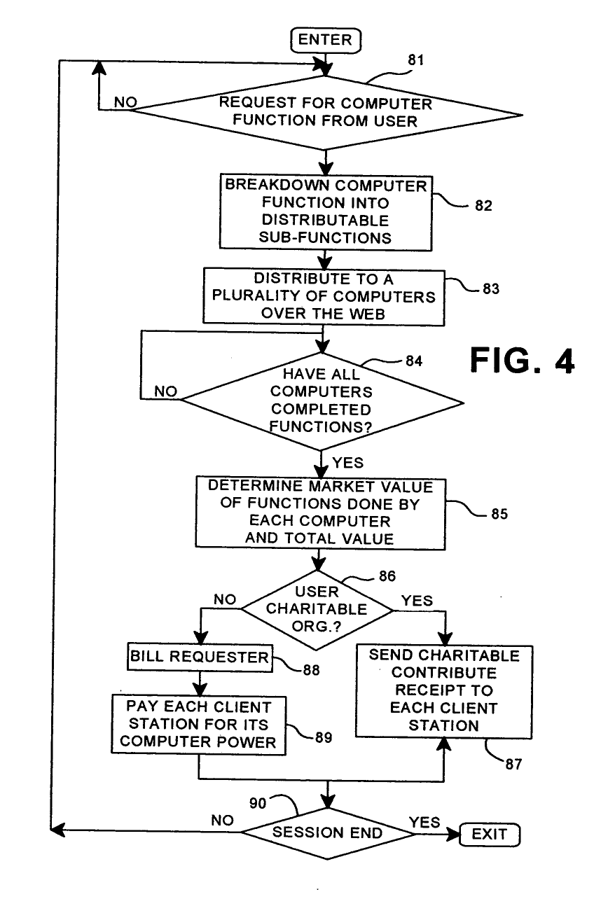

The running of the process set up in FIG. 3 will now be described with respect to the flowchart of FIG. 4. First, step 81, a determination is made as to whether there has been a request for computer power by a user or consumer computer station. If No, such a request is awaited. If Yes, then step 82, the service broker breaks down the requested function into a set of subfunctions. These subfunctions are distributed to a plurality of participating client computers over the Web, step 83. The distributed subfunctions are carried out until a determination is made in step 84 that Yes, all such subfunctions have been completed. Then, step 85, the respective market values of all of the subfunctions performed are calculated, as well as the total market value of the whole function. At this point, a determination is made as to whether the requester or consumer is a charitable organization, step 86. If Yes, then each client is sent a receipt for the value of his computer power supplied as a charitable contribution, step 87. If No, then the requesting consumer station is billed for the total computer power supplied market value, step 88, and each client station is paid for its supplied computer power, step 89. At this point, or after step 87, a determination may conveniently be made as to whether the session is at an end, step 90. If Yes, it is exited. If No, the process is returned to initial step 81 where the next request is awaited.

Although certain preferred embodiments have been shown and described, it will be understood that many changes and modifications may be made therein without departing from the scope and intent of the appended claims.

1. In a system for distributed computing connected via the World Wide Web (Web), a system for tracking distributed computer power to users and compensating computer power providers comprising:
a computer power service broker;
means, associated with said broker, for soliciting each of a plurality of client computer stations on the Web to offer for general distribution over the Web computer power in excess to the computer power requirements of each respective client computer station;
means, associated with said broker, for soliciting a plurality of consumer stations on the Web to request the performance of functions requiring computer power;
means, associated with said broker, for distributing each of said requested functions requiring computer power among a plurality of said client computer stations offering said computer power;
means, associated with said broker, for tracking and for billing consumer stations for computer power used in performance of requested functions; and
means, associated with said broker, for tracking and compensating said client stations for said excess computer power used in performance of said requested functions.

2. The Web system for tracking distributed computer power of claim 1 further including means associated with said broker for determining the market value of computer power provided by each client station in performance of said requested functions.

3. The Web system for tracking distributed computer power of claim 2 wherein said means for compensating said client stations for said computer power pay said client stations the market value of the computer power provided.

4. The Web system for tracking distributed computer power of claim 2 wherein:
said consumer stations requesting the performance of functions requiring computer power are owned by charitable organizations; and
said means compensating said client stations for said computer power compensate said client stations by providing a Web document indicating the contribution of the market value of the computer power supplied.

5. The Web system for tracking distributed computer power of claim 2 wherein the market value of the computer power provided by each client station is determined by the amount of data processed and the type of data processing used in processing the data.

6. The Web system for tracking distributed computer power of claim 1 wherein:
each of said plurality of client stations on the Web offering computer power for distribution further includes means permitting said computer power service broker to access, via the Web, the computer power of said computer station.

7. The Web system for tracking distributed computer power of claim 6 further including means, associated with said broker, for distributing via the Web to said client stations, said means permitting said computer power service broker to access the computer power of said client stations.

8. In distributed computing via the World Wide Web (Web) connections, a method for tracking distributed computer power to users and compensating computer power providers comprising:
soliciting, through a computer power service broker, each of a plurality of client computer stations on the Web to offer for general distribution over the Web computer power in excess to the computer power requirements of each client respective computer station;
soliciting, through a computer power service broker, a plurality of consumer stations on the Web to request the performance of functions requiring computer power;
distributing, through said broker, each of said requested functions requiring computer power among a plurality of said client stations offering said computer power;
tracking and for billing, through said broker, consumer stations for computer power used in performance of requested functions; and
tracking and compensating, through said broker, said client stations for said excess computer power used in performance of said requested functions.

9. The method for tracking distributed computer power of claim 8 further including the step of determining, through said broker, the market value of computer power provided by each client station in performance of said requested functions.

10. The method for tracking distributed computer power of claim 9 wherein said step of compensating said client stations for said computer power pays said client stations the market value of the computer power provided.

11. The method for tracking distributed computer power of claim 9 wherein:
said consumer stations requesting the performance of functions requiring computer power are owned by charitable organizations; and
said step of compensating said client stations for said computer power compensates said client stations by providing a Web document indicating the contribution of the market value of the computer power supplied.

12. The method for tracking distributed computer power of claim 9 wherein the market value of the computer power provided by each client station is determined by the amount of data processed and the type of data processing used in processing the data.

13. The method for tracking distributed computer power of claim 8 wherein:
each of said plurality of client stations on the Web offering computer power for distribution further permits said computer power service broker to access, via the Web, the computer power of said client station.

14. The method for tracking distributed computer power of claim 13 further including the step of distributing through said broker via the Web to said client station, a process permitting said computer power service broker to access the computer power of said client station.

15. A computer program having program code included on a computer readable medium for tracking distributed computer power to users and compensating computer power providers in World Wide Web (Web) distributed computing comprising:
a computer power service broker;
means, associated with said broker, for soliciting each of a plurality of client computer stations on the Web to offer for general distribution over the Web computer power in excess to the computer power requirements of each respective client computer station;
means, associated with said broker, for soliciting a plurality of consumer stations on the Web to request the performance of functions requiring computer power;
means, associated with said broker, for distributing each of said requested functions requiring computer power among a plurality of said client stations offering said computer power;
means, associated with said broker, for tracking and for billing consumer stations for computer power used in performance of requested functions; and
means, associated with said broker, for tracking and compensating said client stations for said excess computer power used in performance of said requested functions.

16. The computer program for tracking distributed computer power of claim 15 further including means associated with said broker for determining the market value of computer power provided by each client station in performance of said requested functions.

17. The computer program for tracking distributed computer power of claim 16 wherein said means for compensating said client stations for said computer power pays said client stations the market value of the computer power provided.

18. The computer program for tracking distributed computer power of claim 16 wherein:
said consumer stations requesting the performance of functions requiring computer power are owned by charitable organizations; and
said means for compensating said client stations for said computer power compensate said client stations by providing a Web document indicating the contribution of the market value of the computer power supplied.

19. The computer program for tracking distributed computer power of claim 15 wherein:
each of said plurality of client stations on the Web offering computer power for distribution further includes means permitting said computer power service broker to access, via the Web, the computer power of said client station.

20. The computer program for tracking distributed computer power of claim 19 further including means, associated with said broker, for distributing via the Web to said client station, said means permitting said computer power service broker to access the computer power of said client station.
